(19) United States
(12) Patent Application Publication
(10) Pub. No.: US 2018/0155118 A1
(43) Pub. Date: Jun. 7, 2018

(54) PACKING PRODUCT

(71) Applicants: RICK TUCKER, RICHARDSON, TX (US); TODD TONORE, MANSFIELD, TX (US)

(72) Inventors: RICK TUCKER, RICHARDSON, TX (US); TODD TONORE, MANSFIELD, TX (US)

(21) Appl. No.: 15/835,423

(22) Filed: Dec. 7, 2017

Related U.S. Application Data
(60) Provisional application No. 62/431,320, filed on Dec. 7, 2016.

(51) Int. Cl. B65D 88/16; B32B 27/08; B32B 27/28; B65D 33/02

(52) U.S. Cl. CPC B65D 88/1681; B32B 27/08; B32B 27/285; B65D 88/1625; B65D 33/10; B65D 33/02; B32B 2371/00; B32B 2250/03; B65D 88/1631

(57) ABSTRACT

A bulk packaging product is described herein. The packaging product includes: trilayered walls in the shape of a rectangular package that can contact a product; wherein the package includes 4 walls; a plurality of baffles attached to two adjacent walls within the package that help maintain the rectangular shape; a plurality of lifting loops attached to at least two corners of the package; and an opening to facilitate filling the package with product.

### BRIEF DESCRIPTION OF THE FIGURES

For a more complete understanding of the present invention, including its features and advantages, reference is now made to the detailed description of the invention taken in conjunction with the accompanying drawing in which:

FIG. 1 is a cut away look at the baffle webbing and double wall bag with plastic corrugated sandwiched between the two plies;

FIG. 2 is a photograph of a Flexstand bag 100;

FIG. 3 is another photograph of a Flexstand bag 100;

FIG. 4 is yet another photograph of a Flexstand bag 100;

FIG. 5 is yet another photograph of a Flexstand bag 100;

FIG. 6 is yet another photograph of a Flexstand bag 100;

FIG. 7 is yet another photograph of a Flexstand bag 100;

FIG. 8 is yet another photograph of a Flexstand bag 100;

FIG. 9 is yet another photograph of a Flexstand bag 100;

FIG. 10 is yet another photograph of a Flexstand bag 100;

FIG. 11 is yet another photograph of a Flexstand bag 100;

FIG. 12 is yet another photograph of a Flexstand bag 100;

FIG. 13 is a side view of the construction of a representative Flexstand bag; and

FIG. 14 shows different views of another representative Flexstand bag.

### DETAILED DESCRIPTION OF THE INVENTION

While making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

A flexible intermediate bulk container (FIBC), bulk bag, or big bag, is an industrial container made of flexible fabric that is designed for storing and transporting dry, flowable products, such as sand, fertilizer, and granules of plastic.

FIBCs are most often made of thick woven polyethylene or polypropylene, either coated or uncoated, and normally measure around 110 cm or 45-48 inches in diameter and varies in height from 100 cm up to 200 cm or 35 to 80 inches. Its capacity is normally around 1000 kg or 2000 lbs., but the larger units can store even more. A bulk bag designed to transport one metric ton of material, will itself only weigh 5-7 lbs.

Transporting and loading is done on either pallets or by lifting it from the loops. Bags are made with either one, two or four lifting loops. The single loop bag is suitable for one man operation as there is no need for a second man to put the loops on the loader hook. Emptying is made easy by a special opening in the bottom such as a discharge spout, of which there are several options, or by simply cutting it open.

There are a great and varied range of uses for FIBC's. Many applications are in industrial uses such as for the storage of powder based and bulk product:

1) Food Industry—Sugar, Salt, Flour, Dextrose, Starch, Food Additives;

2) Chemical Industry;

3) Construction Industry;

4) Agricultural Industry—Seed, Grain, Popcorn, Seeds, Nuts, Potatoes;

5) Crushed Stone, Sand, Gravel, Cement Industry, Clay;

6) Pharmaceutical Industry;

7) Plastics Industry—Absorbent Polymer, Resin, Pellets, Etc.;

8) Mining Industry;

9) Steel—Rebar Industry and Specialty Minerals; and

10) Hazardous Materials Industry.

Three types of the FIBC packaging include the Circular MC; a U-Panel FIBC; and the Baffled FIBC and will be explained in the next few paragraphs.

The Circular FIBC—The circular design is ideal as a linerless option for fine materials. Circular construction eliminates side seams resulting in improved sift and moisture protection. The spread loop design allows for easy fork lift access.

The U-Panel FIBC—The u-panel construction is excellent for a variety of products and has tremendous lifting capacity due to long loops sewn in the seams. A very popular design for dense products.

The Baffled FIBC—with corner baffles to maintain their rectangular or square shape once they are filled and during transportation, and in storage. The corner baffles are made to allow the material flow smoothly into all the corners, yet preventing the hag from expanding in the process.

However, these three types, as well as other types, of packaging each have its weaknesses. Therefore, a need exists that helps resolve the shortcomings of each packaging product that is currently offered with an efficient design that is stackable, durable, reliable and also allows printing on the wails of the packaging product.

One embodiment of the present invention (“heretofore referred to as “Flexstand”) is a semi-rigid FIBC made of 100% recyclable polypropylene components. A tri-wall U-panel design incorporates corrugated polypropylene (PP) sheeting in Four (4) sidewalls located between double wall fabric layers. This sidewall sheeting allows the Flexstand bag to maintain an unsupported rectangular shape when set in position for use. A set of internal web strap baffle belts attached at a right angle to the internal fabric wall provide support to each Ninety (90) degree panel maintaining the geometric shape when products are dispensed into the package. However, external baffles lines are not visible on the outside layer of the Flexstand bag allowing for an unobstructed printing surface. In addition, a set of top and bottom openings allow filling and discharge of the Flexstand bag. These openings can have multiple design characteristics incorporated into the semi rigid Flexstand package body. Moreover, lifting loops, or sleeves, allow for simultaneous pickup points at all four corners. Further, safe working loads for the Flexstand bag range from 1000 to 4000 lbs with a 5 to 1 safety factor.

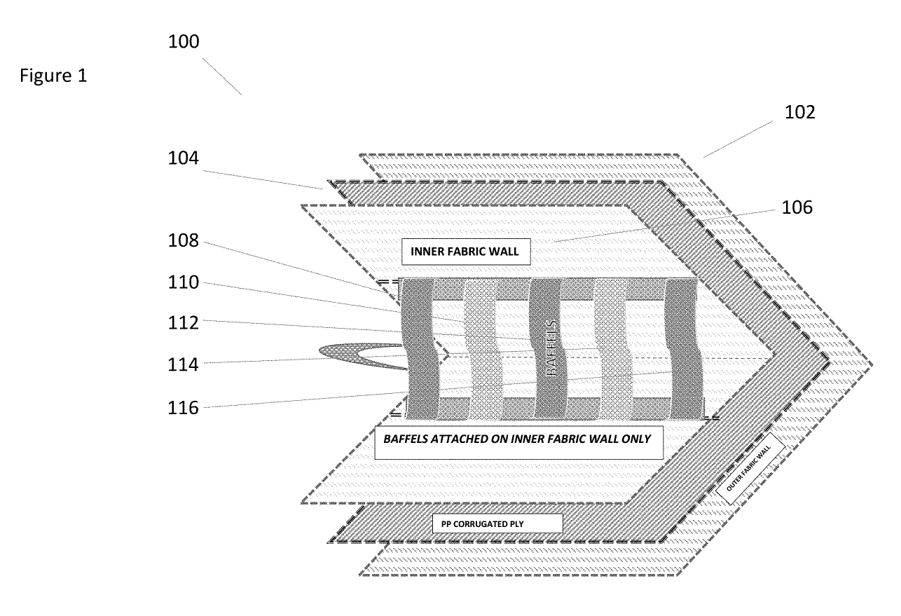

Details are now explained with the help of the attached drawings. Now turning to FIG. 1, a depiction 100 of two walls of the Flexstand bag is shown. The two walls included an outer fabric wall 102, and middle fabric wall 104 made of a PP corrugated ply and an inner fabric wall 106. In this embodiment, Five (5) baffles 108, 110, 112, 114, and 116, are attached to inner fabric wall 106 near the corners of Two (2) adjacent sidewalls

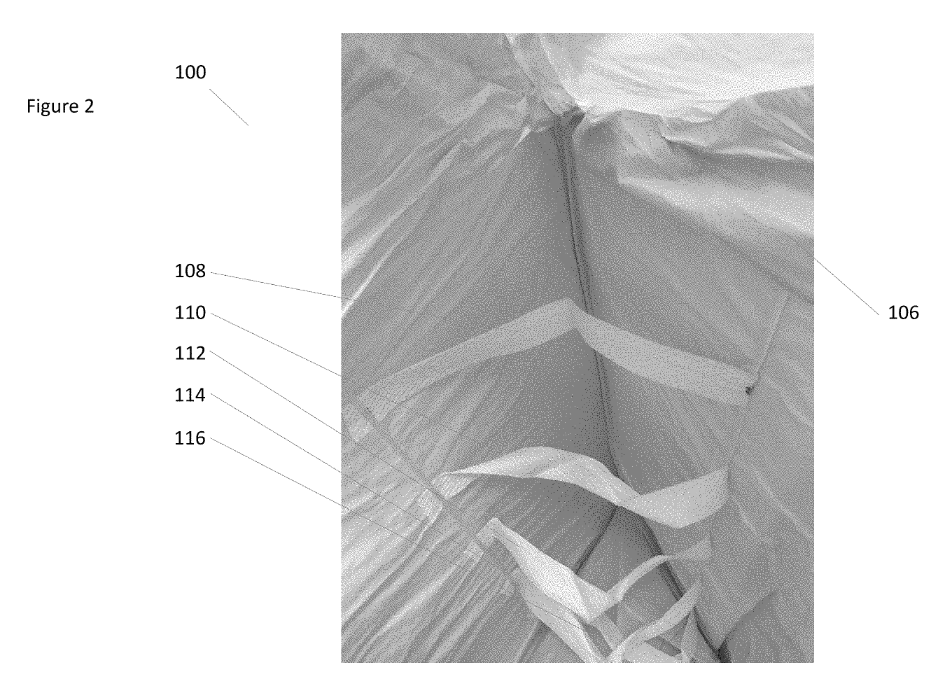

Now turning to FIG. 2, a close-up of the inner wall of two sidewalls are shown. In addition, the Five baffles 108, 110, 112, 114, and 116 are also shown attached to Two (2) adjacent sidewalls. Included in this figure, is one of the lifting loops 300 that can be attached to each corner of the Flexstand bag 100 to enable a person or machine to pick up the Flexstand 100.

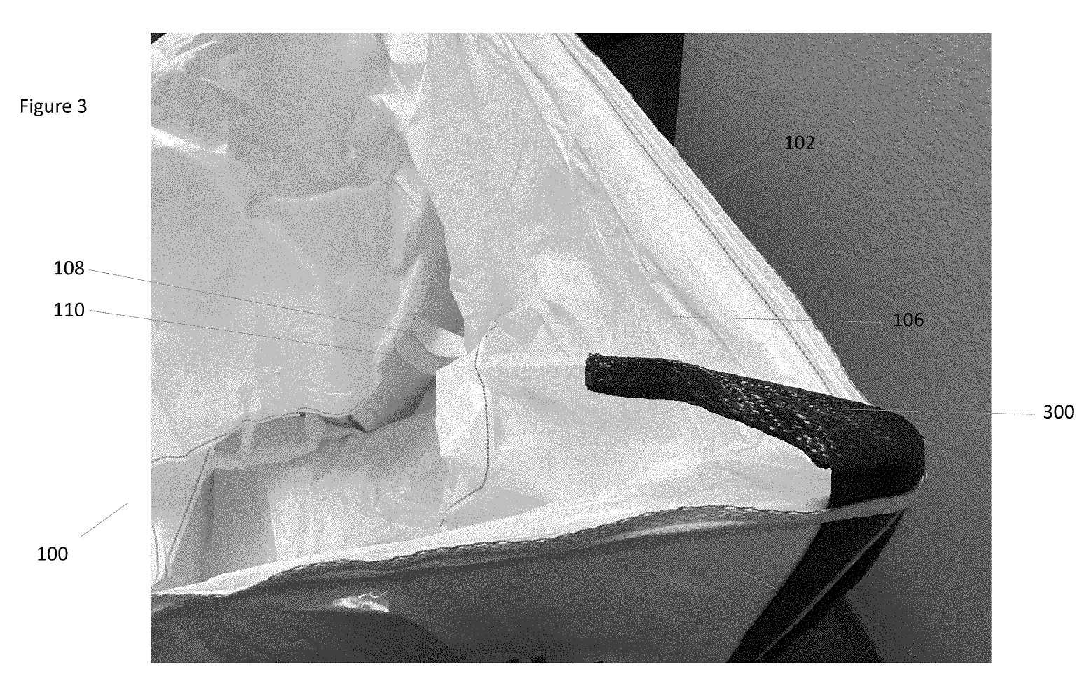

Now turning to FIG. 3, another close-up of the Flexstand bag 100 with two baffles 108, 110. Also shown, is the other wall 102 and the inner wall 106.

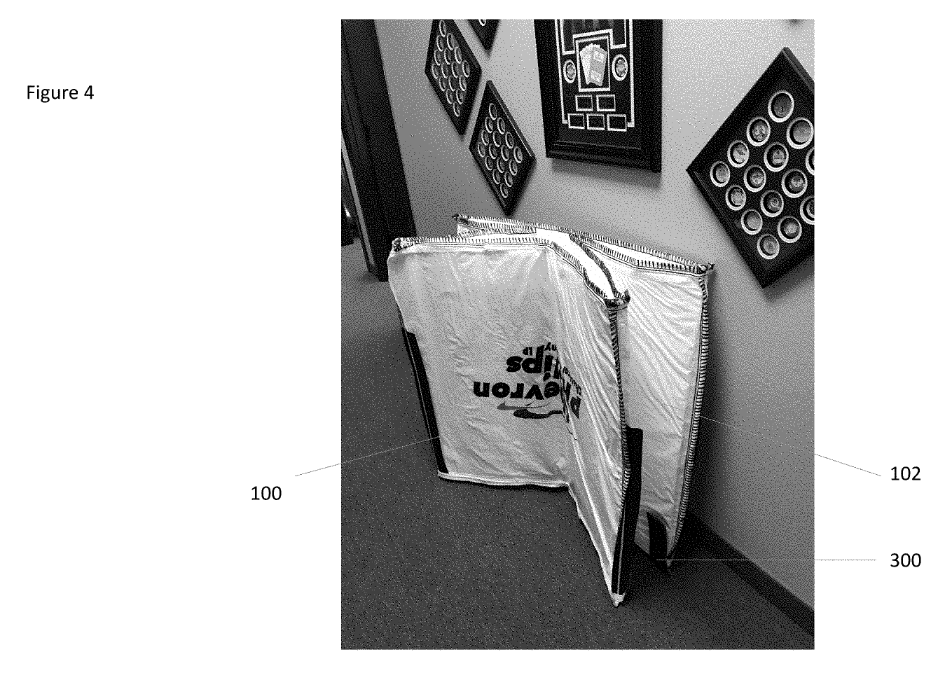

Now turning to FIG. 4, another Flexstand bag 100 is shown with at least one lifting loop 300 attached to the outer wall 102.

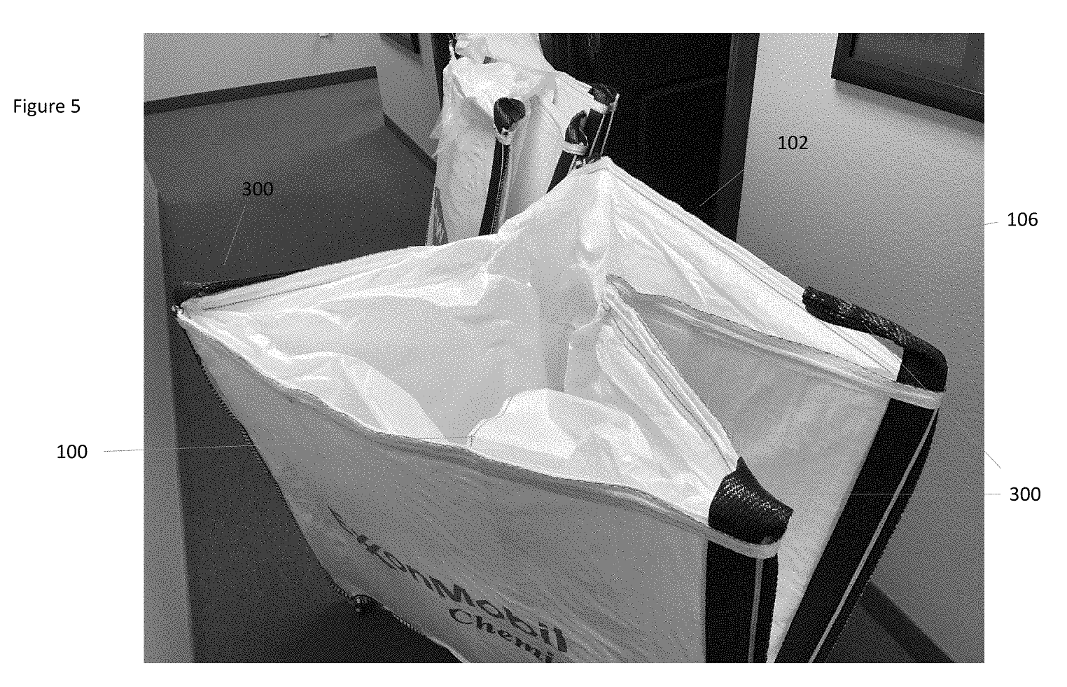

Now turning to FIG. 5, another Flexstand bag 100 is shown including outer wall 102, inner wall 106 and three lifting loops 300.

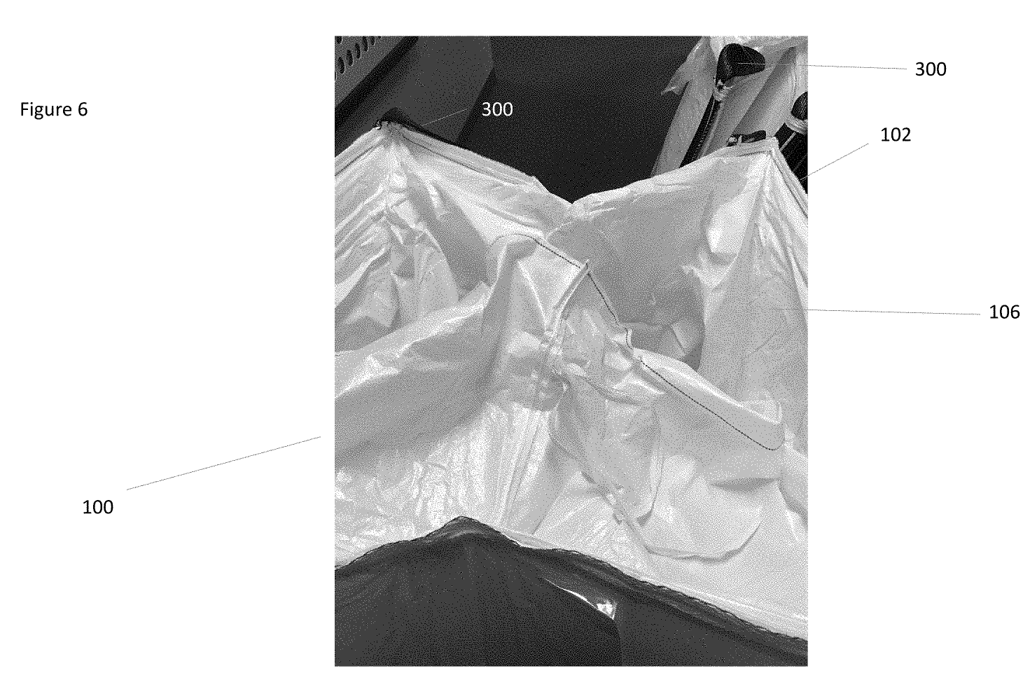

Now turning to FIG. 6, another Flexstand bag 100 is shown including outer wall 102, inner wall 106 and two lifting loops 300.

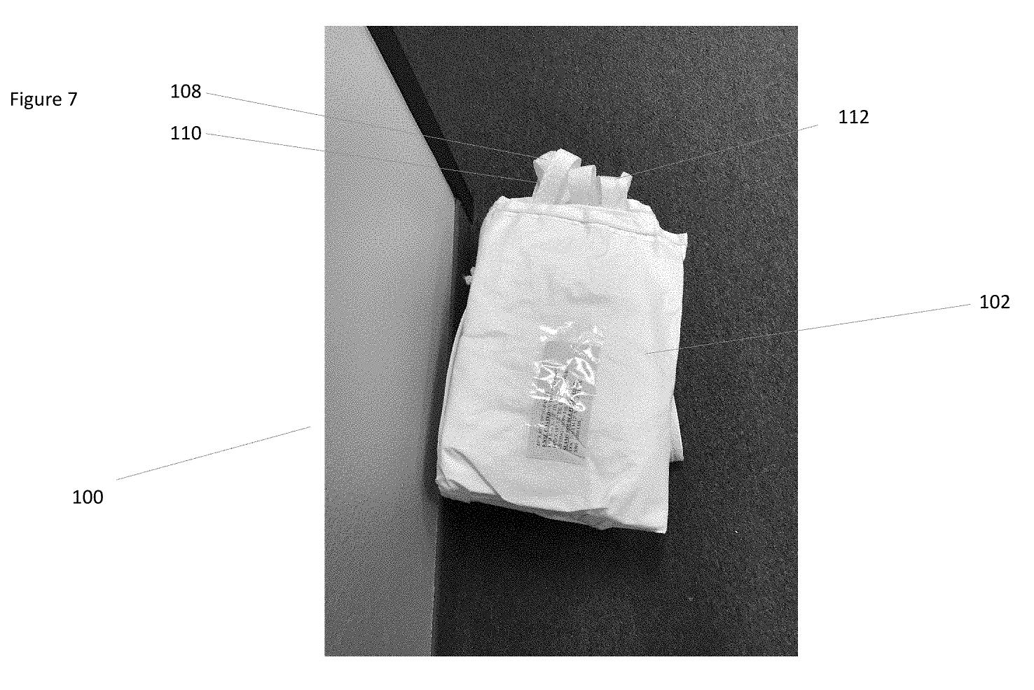

Now turning to FIG. 7, another Flexstand bag 100 is folded and shows outer wall 102 and three baffles 108, 110 and 112.

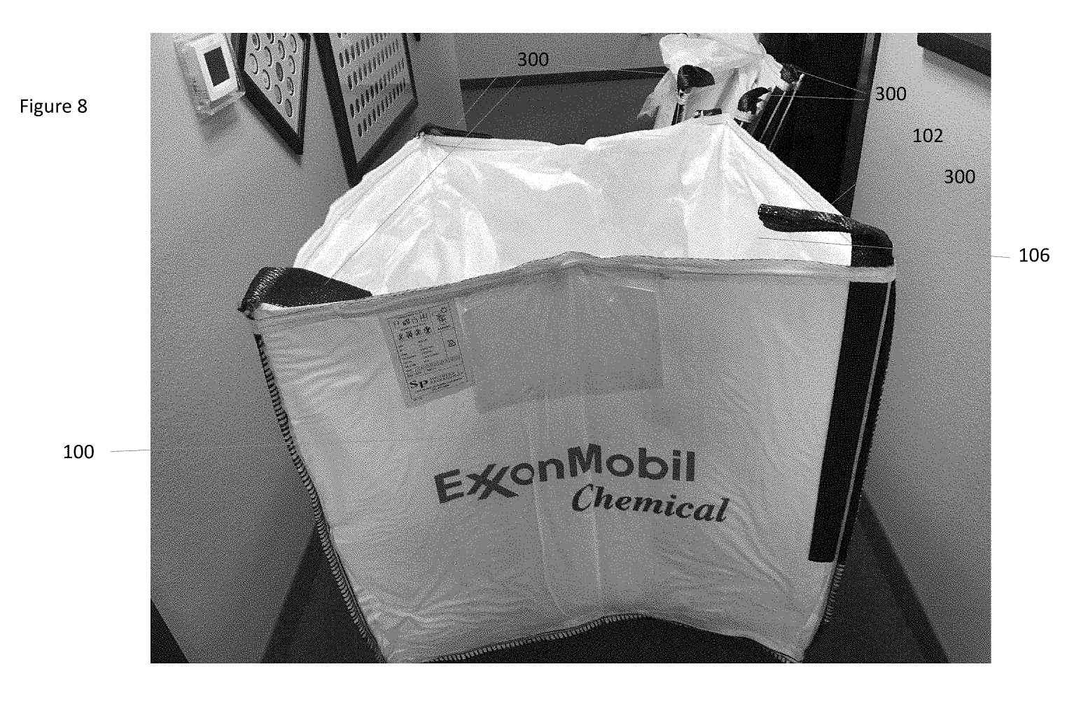

Now turning to FIG. 8, another Flexstand bag 100 is shown including outer wall 102, inner wall 106 and five lifting loops 300.

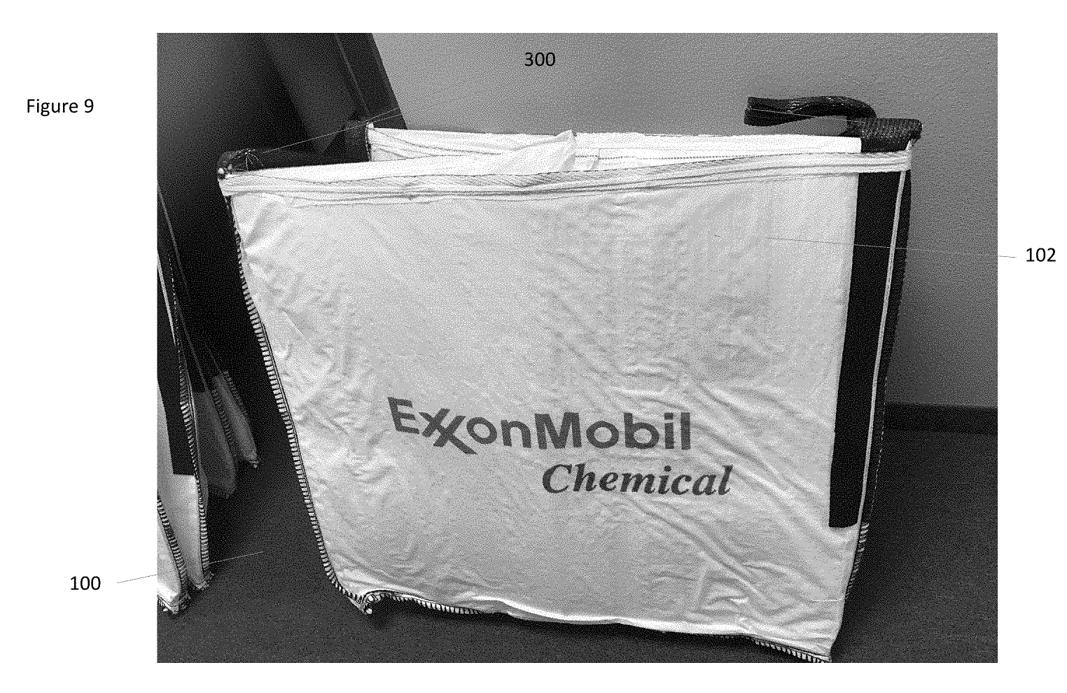

Now turning to FIG. 9, another Flexstand bag 100 is shown including outer wall 102, and four lifting loops 300.

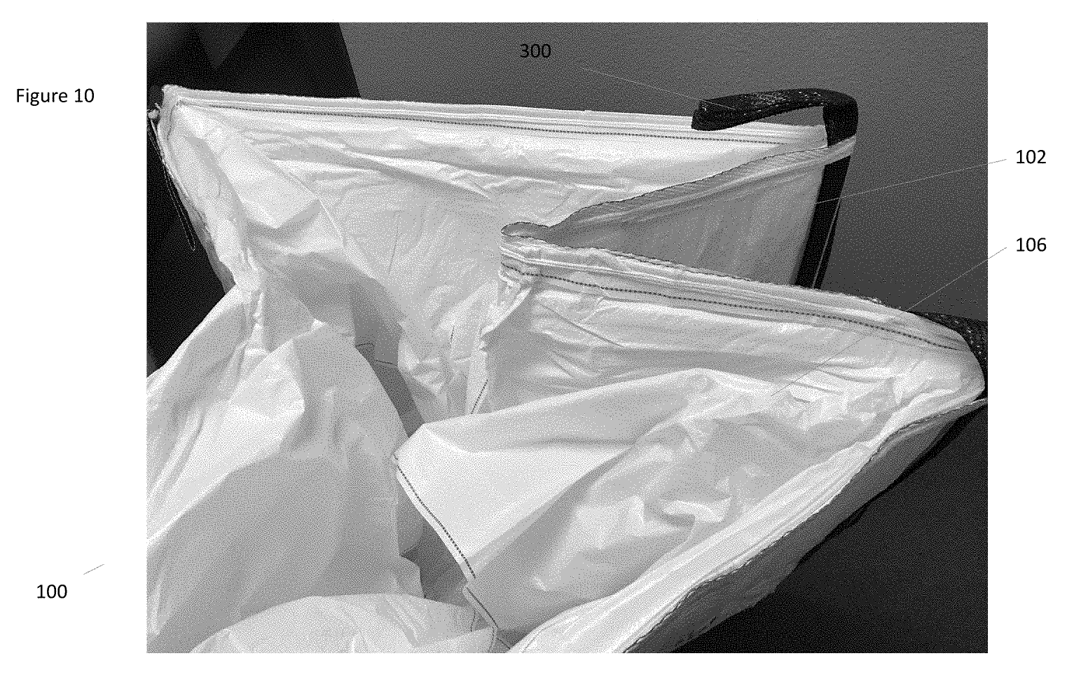

Now turning to FIG. 10, another Flexstand bag 100 is shown including outer wall 102, inner wall 106 and one lifting loop 300.

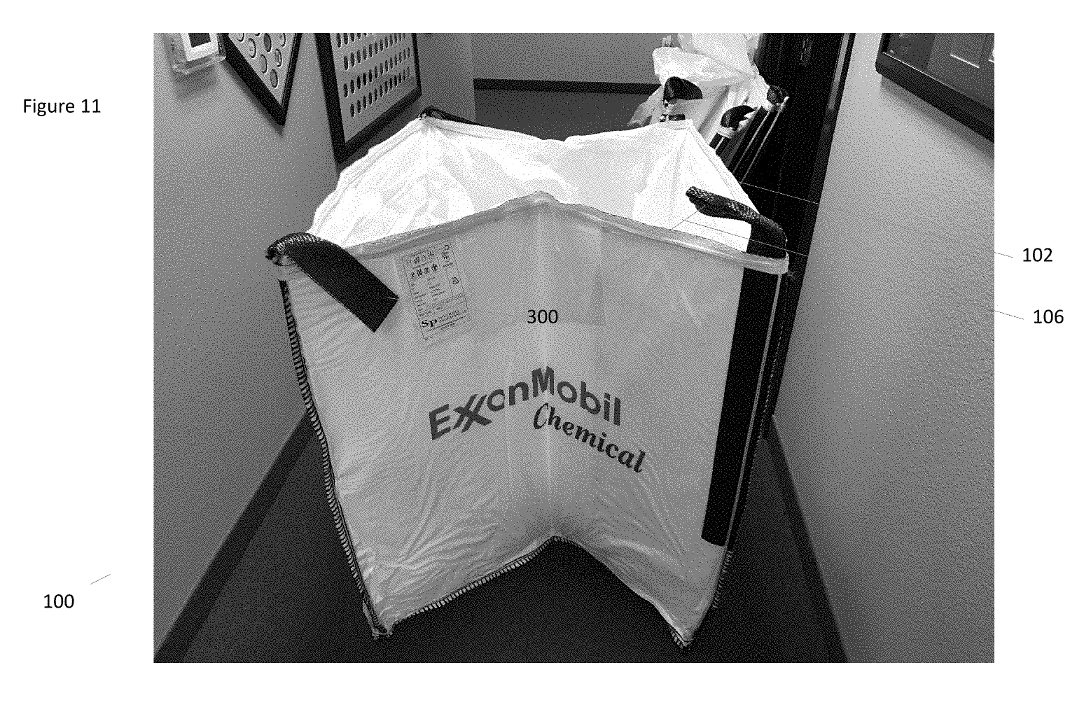

Now turning to FIG. 11, another Flexstand bag 100 is shown including outer wall 102, inner wall 106 and two lifting loops 300.

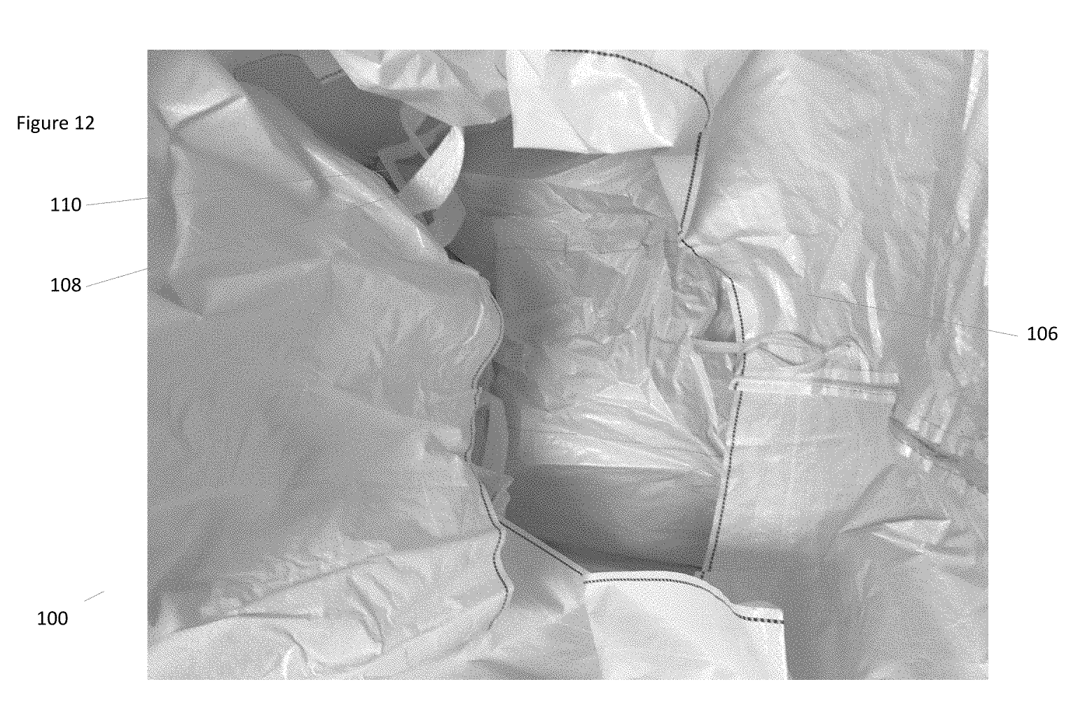

Now turning to FIG. 12 another Flexstand bag 100 is show with an inner wall 106 and two baffles 108 and 110.

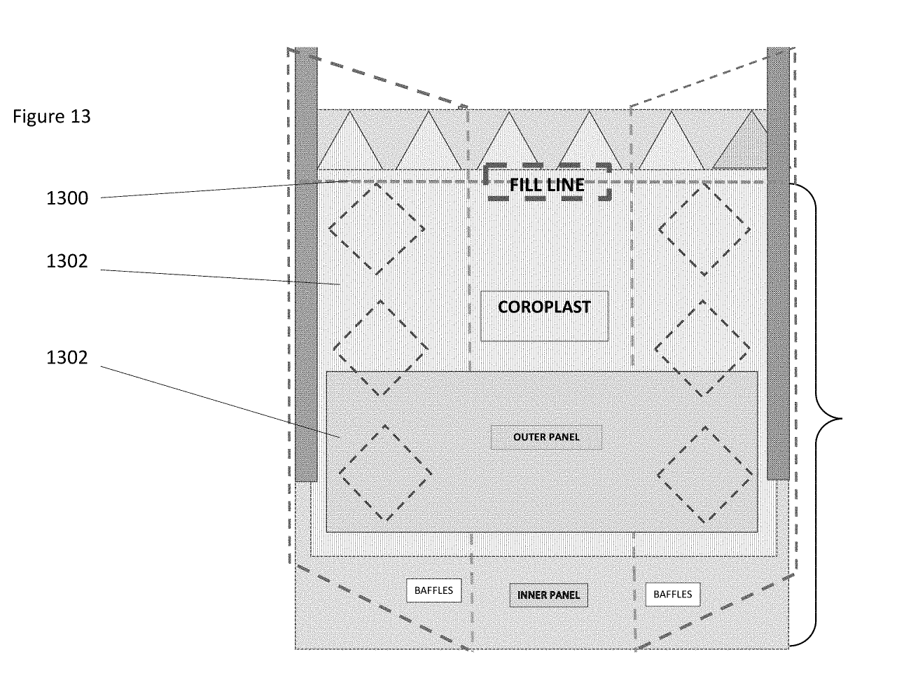

Now turning to FIG. 13, a side view of the construction of a representative Flexstand bag. In this figure, a set of equilateral triangular is shown at the top of the Flexstand bag. In this embodiment, these triangular shapes at the top of the sheet are divisible by 5 to the width of the side panel. The 5 points maintain the side panel structure and fold to level 1300 of the filled bag when an additional bag (not shown) is stacked on top of the bottom bag.

In this embodiment, two coroplast sheets 1302 are sewn into opposite side panels and remain part of the bag structure. The two side panels with coroplast give the bag structure and allow the form to stay open and erect. The other opposite side panels have no coroplast sheets.

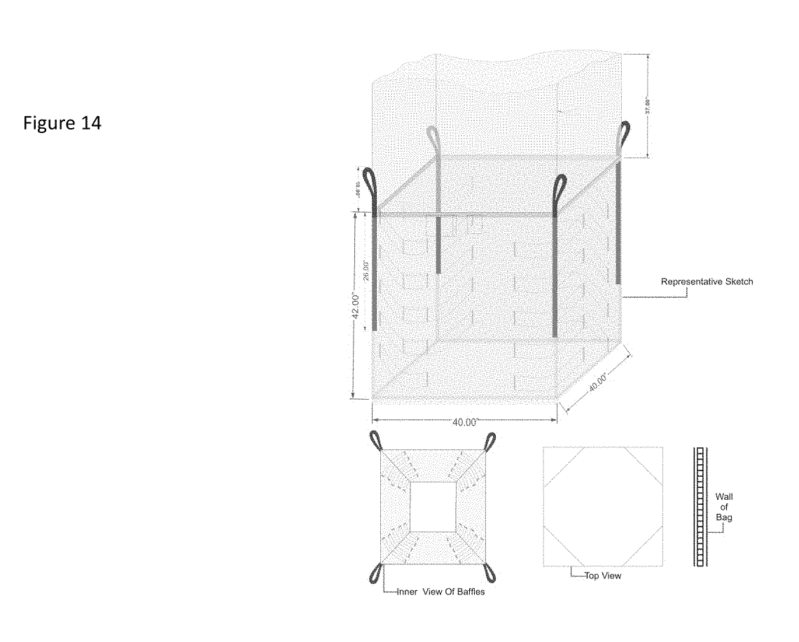

Now turning to FIG. 14, this figure shows different views of another representative Flexstand bag. The top bag is shown from a side perspective indicating baffles on each corner as well as pull tabs on each of the four corners. Example dimensions are also shown. Another perspective from a top view is shown that indicate how the baffles and pull tabs may be viewed from the top of the bag. A third view is shown from the top along a perspective view of one possible construction of the wall of the Flexstand bag.

An embodiment of the present invention is a semi-rigid FIBC which can be made of recyclable polypropylene components (one alternative is the have invention made up of 100% recyclable polypropylene components). This embodiment includes a tri-wall U-panel design which can incorporate corrugated polypropylene sheeting in the four (4) sidewalls located between the double wall fabric layers. The sidewall sheeting allows the bag to maintain an unsupported erect rectangular shape when setup for usage. Internal web strap baffle belts attached at a right angle to the internal fabric wall provide support to each ninety (90) degree panel maintaining the geometric shape when products are dispensed into the package. External baffles lines are not visible on the outside layer allowing for an unobstructed printing surface. Top and bottom filling and discharge openings can have multiple design characteristics incorporated into the semi rigid package body. Lifting loops or sleeves allow for simultaneous pickup points at all four corners. Safe working loads range from 1000 to 4000 lbs. with a 5 to 1 safety factor.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

We claim:

1. A bulk packaging product, the product comprises:
trilayered walls in the shape of a rectangular package that can contact a product; wherein the package includes 4 walls;
a plurality of baffles attached to two adjacent walls within the package that help maintain the rectangular shape;
a plurality of lifting loops attached to at least two corners of the package; and
an opening to facilitate filling the package with product.
